(19) United States
(12) Patent Application Publication
(10) Pub. No.: US 2017/0119624 A1
(43) Pub. Date: May 4, 2017

(54) LEG PILLOW FOR PHYSIOTHERAPY

(71) Applicants: Hee Soo KIM, Hanam-si, Gyeonggi-do (KR); T&I CO., LTD., Namyangju-si, Gyeonggi-do (KR)

(72) Inventor: Hee Soo KIM, Hanam-si, Gyeonggi-do (KR)

(73) Assignees: T&I CO., LTD, Namyangju-si, Gyeonggi-do (KR); Hee Soo KIM, Hanam-si, Gyeonggi-do (KR)

(21) Appl. No.: 15/317,109

(22) PCT Filed: Jun. 11, 2015
(86) PCT No.: PCT/KR2015/005868

§ 371 Date: Dec. 7, 2016

(30) Foreign Application Priority Data
Jun. 11, 2014 (KR) 10-2014-0070975

(51) Int. Cl. A61H 37/00; A47C 20/00; A47G 9/10

(52) U.S. Cl. CPC A61H 37/00; A47G 9/10; A47C 20/021; A47G 2009/1018; A61H 2205/106; A61H 2205/12

(57) ABSTRACT

Disclosed is a leg pillow for physiotherapy including a fixed bottom surface part forming a bottom surface of a fixing groove in which the legs of a person are seated; and a sidewall part extending upward from the fixed bottom surface part to form a side surface of the fixing groove. The sidewall part supports the legs of a user to prevent both legs of the user from moving in directions away from each other.

### TECHNICAL FIELD

The present invention relates to a leg pillow for physiotherapy, and more particularly, to a leg pillow for physiotherapy which adopts an ankle still point inducing technique of craniosacral therapy.

### BACKGROUND ART

A craniosacral therapy (CST) is a therapeutic method that has begun to be researched in U.S.A., and has a history of over 100 years. The craniosacral therapy may solve various problems caused by deterioration in circulation of a cerebrospinal fluid which are caused by membranous impairment of a central nerve system.

In the case of the normal circulation of the cerebrospinal fluid, the cerebrospinal fluid circulates in a flexion (inspiration, external rotation) pattern and in an extension (expiration, internal rotation) pattern in a cycle of 8 to 12 times per minute (the flexion and the extension cycle: once per 6 to 9 seconds), a cycle of circulation of the cerebrospinal fluid through the entire body is once per 6 to 7 hours, the cerebrospinal fluid circulates four to five times a day, and the amount of the created cerebrospinal fluid is 500 cc for a day.

The normal flow of the cerebrospinal fluid (CSF) relieves tension of membranes that surround the brain and the spinal cord which are included in a central nerve system, and relieves tension of the fasciae connected to all external tissue, thereby improving circulation ability of all of capillaries and cells in the whole body, and operating a self-curative immune system.

The craniosacral therapy is a therapeutic method of adjusting a flow cycle of the cerebrospinal fluid to normal balance by precisely touching cranial bones and sacra with about 5 grams of force by hand and releasing restricted intracranial membranes and dura maters.

The balance of the cerebrospinal fluid has effects of reducing headache, muscle tension of a posterior region of a neck, neck stiffness, shoulder muscle pain, fever, acute and chronic musculoskeletal diseases, low back pain, degenerative arthritis, cerebral congestion, pulmonary congestion, and edema.

Therefore, it is necessary to easily utilize the craniosacral therapy even at home by using the still point inducing technique by using the leg pillow which adopts the craniosacral therapy, and by applying a manipulative therapeutic technique, which induces normal circulation of the cerebrospinal fluid, to products.

### DISCLOSURE

### Technical Problem

The problems to be solved by the present invention are as follows.

A first object is to provide a leg pillow for physiotherapy capable of allowing any person to be easily subjected to craniosacral therapy.

A second object is to allow the user to be subjected to the craniosacral therapy without limitations in respect to time and space.

Technical problems of the present invention are not limited to the aforementioned technical problems, and other technical problems, which are not mentioned above, may be clearly understood by those skilled in the art from the following descriptions.

### Technical Solution

To solve the aforementioned problems, a leg pillow for physiotherapy according to an exemplary embodiment of the present invention includes: fixing bottom portions which define bottom surfaces of fixing grooves on which a user's feet are seated; and sidewall portions which extend upward from the fixing bottom portions and define lateral surfaces of the fixing grooves, in which the sidewall portions support the user's feet so as to prevent the user's feet from being moved outward away from each other.

In addition, a leg pillow for physiotherapy according to another exemplary embodiment of the present invention includes: fixing bottom portions which define bottom surfaces of fixing grooves on which a user's feet are seated; accommodating bottom portions which are connected with the fixing bottom portions in a stepped manner, and define bottom surfaces of accommodating grooves that accommodate a user's calves and thighs; and sidewall portions which define lateral surfaces of the fixing grooves and the accommodating grooves, in which heights of the sidewall portions are gradually decreased in a direction from the user's end to the user's calf so that the fixing groove is deeper than the accommodating groove.

In addition, a leg pillow for physiotherapy according to still another exemplary embodiment of the present invention includes: fixing bottom portions which define lower surfaces of fixing grooves on which a user's feet are seated; and sidewall portions which extend upward from the fixing bottom portions and define lateral surfaces of the fixing grooves, in which the sidewall portions interrupt the movement of the user's feet so as to interrupt the flexion phase of ankles in craniosacral rhythm caused by a flow of a cerebrospinal fluid.

Other detailed matters of the exemplary embodiment are included in the detailed description and the drawings.

### Advantageous Effects

According to the exemplary embodiment of the present invention, there are one or more effects as follows.

First, a curative effect according to the craniosacral therapy may be obtained by seating the feet on the leg pillow.

Second, the craniosacral therapy may be applied as long as a place on which a user may lie is provided, thereby reducing restrictions to time and space.

The effects of the present invention are not limited to the aforementioned effects, and other effects, which are not mentioned above, will be clearly understood by those skilled in the art from the claims.

### DESCRIPTION OF DRAWINGS

FIG. 1 is a view illustrating a state in which a practitioner performs craniosacral therapy on a patient.

FIG. 2 is a perspective view of a leg pillow for physiotherapy according to one exemplary embodiment of the present invention.

FIG. 3 is a front view of the leg pillow for physiotherapy according to one exemplary embodiment of the present invention.

FIG. 4 is a rear view of the leg pillow for physiotherapy according to one exemplary embodiment of the present invention.

FIG. 5 is a view briefly illustrating a leg part of a human body.

FIG. 6 is a cross-sectional view taken along line A-A of FIG. 3.

FIG. 7 is a top plan view of the leg pillow for physiotherapy according to one exemplary embodiment of the present invention.

FIG. 8 is a conceptual view illustrating an operation of the leg pillow for physiotherapy according to one exemplary embodiment of the present invention.

FIG. 9 is a view illustrating a state in which a central nerve system including a brain and a spinal cord is filled with a cerebrospinal fluid.

### BEST MODE

Advantages and features of the present disclosure and methods of achieving the advantages and features will be clear with reference to exemplary embodiments described in detail below together with the accompanying drawings.

However, the present invention is not limited to the exemplary embodiments set forth below, and may be embodied in various other forms. The present exemplary embodiments are for rendering the disclosure of the present invention complete and are set forth to provide a complete understanding of the scope of the invention to a person with ordinary skill in the technical field to which the present invention pertains, and the present invention will only be defined by the scope of the claims. Throughout the specification, the same reference numerals denote the same constituent elements.

Hereinafter, the present invention will be described through exemplary embodiments of the present invention with reference to the drawings for explaining a leg pillow for physiotherapy.

It has been conventionally known that because cranial bones of an adult are hardened and calcified, the cranial bones coalesce in the hardened state, such that the cranial bones cannot be moved. However, it has been recently found that the cranial bones are moved to affect or be affected by a movement of a sacrum (an upper side of a coccyx). Craniosacral therapy depends on the movement of the cranial bones. The craniosacral therapy shows efficacies in respect to autism, children's distractibility, headache, low back pain, depressive disorder, and incurable diseases. In particular, the craniosacral therapy causes no side effect, and is a field which may be usefully utilized for persons who require mental and physical comfort, mental stability, and a comfortable life.

A craniosacral rhythm can be sensed by hand. The craniosacral rhythm shows information about stress or immunity. The craniosacral movement of a healthy person is very stable. The craniosacral movement includes flexion and extension. The flexion refers to expansion or inflation. The feeling of the flexion transmitted to the hand can be understood as ‘a feeling that a body expands’ or ‘a feeling that the entire body rotates outward and becomes wide’, and the flexion is also called ‘an external rotation’.

The extension refers to an opposite concept or an opposite feeling to the flexion. The extension can be understood as contraction. The extension can be understood as ‘a feeling that a body is deeply drawn’. In some instances, the extension is explained as a feeling that the entire body rotates inward and becomes narrow. The extension is also called ‘an internal rotation’. The cycle of the craniosacral movement includes two processes of the ‘flexion’ and the ‘extension’ or the ‘expansion’ and the ‘contraction’. A point between the flexion and the extension may be called ‘a neutral point’. At the neutral point, the human body feels that the human body is stopped, and the human body is in a ‘release’ state in which tension is relaxed. The cycles of the flexion and the extension may be constant and equal to each other. If the cycles of the flexion and the extension are different from or are not coincident with each other, the human body may have abnormality. First, a procedure of the craniosacral therapy will be described.

A practitioner should not aggressively treat a human body, and should not impact on or frighten the human body with a large amount of force. A large amount of force, which causes non-physiological movements of the craniosacral system, should not be exerted. The force exerted on the craniosacral system should be about 4 to 5 g, and the reason why such a small amount of force is exerted is to allow the cranial bones to find and move along a new route. The discovery of the new route of movability, which is created as described above, causes newly added motility and free movements.

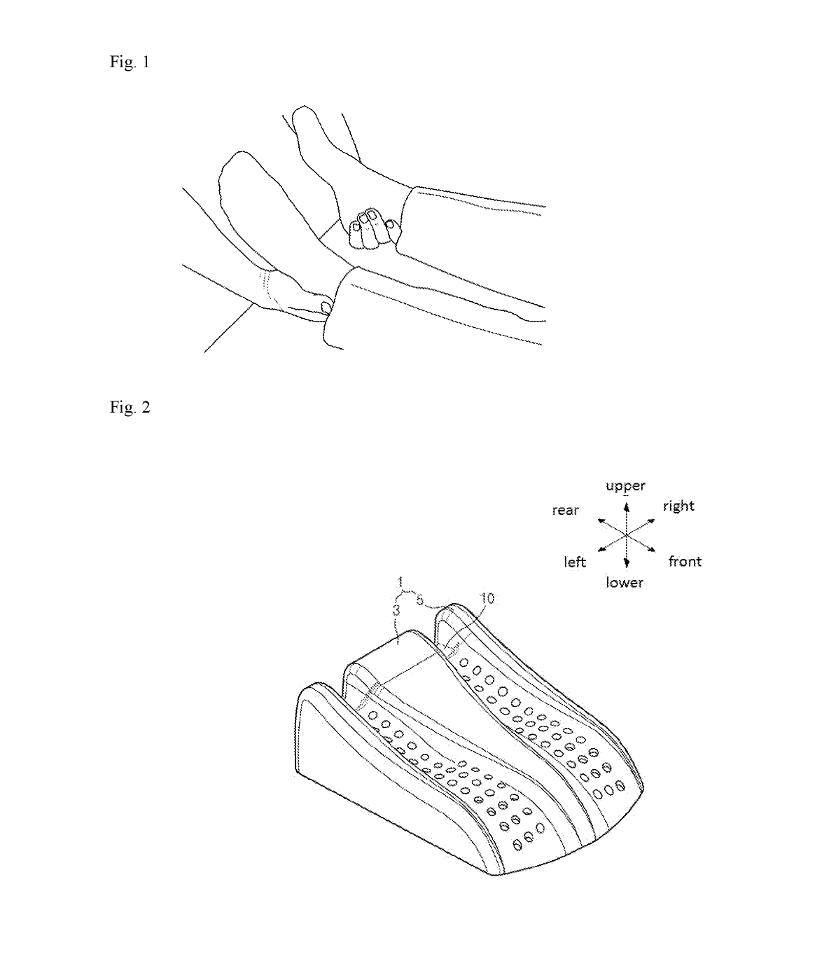

FIG. 1 is a view illustrating a state in which a practitioner performs craniosacral therapy on a patient. Referring to FIG. 1, in order to learn how to smoothly adjust the movement of the craniosacral system, it is preferred to use the patient's feet first. The practitioner closely surrounds the patient's heels with both hands, and then needs to feel rhythmical movements of the craniosacral system by quietly concentrating his/her mind, and needs to sense an external rotation (=the flexion phase of the craniosacral movement), restoration to a neutral position, and an internal rotation (=the extension phase of the craniosacral movement) which are ceaselessly generated in the patient's craniosacral system. The human body moves in the order of an exterior body, an intermediate position, and an interior body in accordance with several composite movements such as a rhythm of the cranial bones, a rhythm of respiration, and a rhythm of the heart, and then very minutely and rhythmically moves again in the order of the interior body, the intermediate position, and the exterior body. The practitioner needs to sense the minute movement with both hands, and move the hands along with the movement.

The practitioner senses whether the patient's feet move symmetrically, whether any one foot more easily moves by the external rotation, or whether any one foot more easily moves by the internal rotation. For example, any one foot may rotate further outward, or the external rotation may be uniform, but the internal rotation may be non-uniform. To change the incomplete state, the practitioner moves the hands up to the maximum movable range in which the patient's feet may be moved. Thereafter, the practitioner holds and fixes the foot, which is about to further rotate outward, so as for the foot not to be moved, thereby preventing the patient's foot from returning back to the neutral position. That is, the practitioner may prevent the patient's foot at the maximum external rotation position from returning back to the neutral position.

While the practitioner smoothly exerts force in order to prevent the patient's foot from returning back to the neutral position, another practitioner, who touches the patient's head, senses minute resistance against an effort in that the cranial bones are about to return back to the neutral position, and thus the movement of the craniosacral system is about to return in the extension direction. The movements, in which the cranial bones are about to return back to the neutral position, and thus the movement of the craniosacral system is return in the extension direction, are created at the head side even though the movements are not sensed easily and simultaneously. These changes sensed at the head side are caused by resistance that occurs as the practitioner adjusts the patient's foot. When the craniosacral system returns back to the flexion phase, the practitioner may sense an increase in external rotation of one foot or feet.

In this case, the hands of the practitioner follow the external rotation. When the external rotation reaches a maximum limit range of a new movement and the craniosacral system is about to return back to the neutral position, the practitioner fixes the patient's feet with both hands so that the patient's feet are not moved again. In this case, several parts of the craniosacral system inevitably return back to the neutral position Thereafter, the craniosacral system moves back to the extension phase against the newly increased resistance.

While procedures of carefully pulling the loosened parts again and interrupting the internal rotation are repeatedly carried out, a range in which the external rotation may be carried out for each time is gradually increased. After these procedures are repeated several times, that is, roughly 5 to 20 times, the overall movement of the craniosacral system disappears, and thus the craniosacral system is in a completely stopped state. This state is called a still point. The still point is created semi-compulsorily by resistance of the practitioner against the physiological movement generated in the patient's feet. In general, this means that generally irregular movements of the craniosacral system occur in the entire human body tissues.

The craniosacral system may show the movement such as spasm, pulsation, or swaying, and if the practitioner tries to continuously provide resistance against the restoration of the patient's feet to the neutral position of the physiological movement, the activity of the craniosacral system is consequently stopped. That is, the still point occurs. When the still point occurs, a patient may experience several changes. When the still point state is reached, the patient may experience that a waist pain, which has occurred before, occurs again or various inactive pains, which has occurred before, recurs. In addition, the patient's breathing is changed, or may have a slightly sweating brow.

During the still point process, the human body begins to be relaxed. From this point, the pains, which have occurred before, disappear slowly. Further, sacroiliac somatic dysfunction at the waist and the pelvis begins to be corrected naturally. In some instances, joints are corrected with a snap. Subsequently, the patient's breathing also becomes steady, and tensed muscles begin to be relaxed. The still point is maintained from as short as several seconds to as long as several minutes. When the still point phenomenon ends, the movement of the craniosacral system begins again. From the general observation, amplitude of a symmetrical and increased movement is detected.

After the still point occurs, a movable range and a qualitative change of the movement, which occur only in the feet, need to be observed. If the internal rotation and the external rotation are carried out within the same range and the left and right movements form symmetry, any further procedure is not required. As a result of judgment of the practitioner, if the movements of the feet are not sufficiently improved to be symmetrical to each other, the practitioner needs to allow the patient to reach the still point again. When the patient reaches the still point by repeating the above method, a pathological state gradually becomes better to a normal state. Therefore, even though the still point is carried out several times, no particular side effect occurs except that the patient is extremely relaxed and gets into a sleep.

The practitioner's hands follow the movement of any part of the patient up to the physiological end point, and interrupt the restoration to the neutral state. Next, the loosened parts are pulled until the still point of the function of the craniosacral system occurs. Further, when the still point ends, the craniosacral activity becomes better, and the movement is symmetrically restored, the practitioner needs to investigate and evaluate a form of a newly created physiological movement of the craniosacral system. The still point occurs most frequently at the head and the sacrum. When various techniques are applied to the head and the sacrum, the still point effect typically occurs more slightly quickly at the head and the sacrum than at the other portions. The still point is effective in smoothly adjusting an action of the craniosacral system.

Hereinafter, a leg pillow for physiotherapy according to one exemplary embodiment of the present invention, which adopts the craniosacral therapy, will be described. Based on a state in which a user seats the feet on the leg pillow while lying and looking at a ceiling, a direction toward the user's body is defined as a front side, a direction toward the user's sole is defined as a rear side, a direction toward the user's right foot is defined as a right side, a direction toward the user's left foot is defined as is defined as a left side, a front side of the user is defined as an upper side, and a rear side of the user is defined as a lower side.

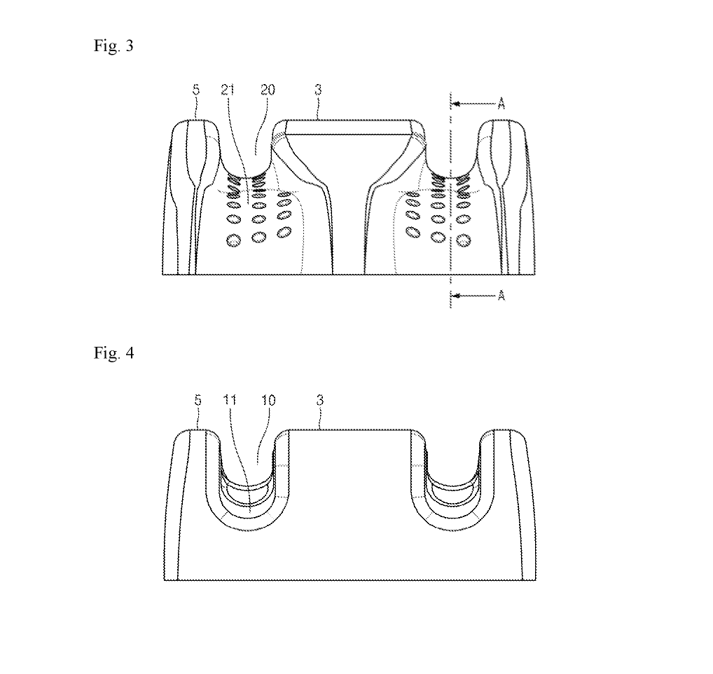

FIG. 2 is a perspective view of the leg pillow for physiotherapy according to one exemplary embodiment of the present invention.

Referring to FIG. 2, the leg pillow for physiotherapy according to one exemplary embodiment of the present invention includes: fixing bottom portions 11 which define bottom surfaces of fixing grooves 10 on which the user's feet are seated; and sidewall portions 1 which extend upward from the fixing bottom portions 11 and define lateral surfaces of the fixing grooves 10, and the sidewall portions 1 exert separate force or reaction force F1 and F2 on the user's feet in order to prevent the user's feet from being moved away from each other.

The fixing groove 10 is formed in a roughly U or V shape, and accommodates the user's foot. Because the fixing groove 10 is opened at an upper side thereof, the user may easily seat the foot in the fixing groove 10 in a state in which the user lies.

The fixing bottom portion 11 defines the bottom surface of the fixing groove 10, and is formed to correspond to the user's heel, that is, a heel bone. The fixing bottom portion 11 may support a heel bone 49. The fixing bottom portion 11 is curvedly formed to accommodate the heel bone 49.

The sidewall portion 1 may be disposed in a direction facing the user's malleolus 47. The sidewall portion 1 extends upward from the fixing bottom portion 11. The sidewall portions 1 exert separate force or reaction force on the user's feet. The sidewall portions 1 exert separate force or reaction force F1 and F2 on the user's feet so as to eliminate the movement of the craniosacral system. The sidewall portions 1 support the user's feet and interrupt the flexion phase, thereby inducing the still point.

The sidewall portions 1 include outer sidewall portions 5, respectively, which stand up outside the user's feet. The sidewall portion 1 may be formed as an elastic member which is deformed by a weight of the user's foot and imparts elastic force to the user's foot. The sidewall portion 1 may be formed as the elastic member that imparts the elastic force F1 and F2 in a direction toward an interior of the fixing groove 10.

The outer sidewall portion 5 stands up at a position that corresponds to the user's outer malleolus 47. The outer sidewall portion 5 stands up at a position that corresponds to the user's little toe. The outer sidewall portion 5 extends upward from the fixing bottom portion 11.

When the extension phase is converted into the flexion phase, the user's feet experience the external rotation, that is, rotate outward. The feet exert external force on the sidewall portions 1 during the flexion phase. The sidewall portions 1 exert separate force or reaction force on the user's feet during the flexion phase. Therefore, the external rotation of the user's feet is interrupted, and when this phenomenon is repeated periodically, the rhythm of the craniosacral system is temporarily stopped, and the movement disappears, such that the still point is experienced.

The outer sidewall portion 5 is a structure that stands up to face the user's foot, and exerts appropriate separate force or reaction force on the user's feet. The craniosacral therapy needs to exert low reaction force on the body while corresponding to the minute movement of the body, and as a result, the leg pillow may be made of a material, such as memory foam, which is soft and has excellent restoring force and elastic force, but the leg pillow may vary for each race, culture, and natural environment, and as a result, hardness may be adjusted to be fixed or adjusted to a soft degree so as to be suitable for the race, the culture, and the natural environment. The sidewall portion 1 may be formed integrally with the fixing bottom portion 11.

The leg pillow for physiotherapy according to one exemplary embodiment of the present invention includes: the fixing bottom portions 11 which define the lower surfaces of the fixing grooves 10 that accommodate the user's feet; and the sidewall portions 1 which extend upward from the fixing bottom portions 11 and define the lateral surfaces of the fixing grooves 10, and the sidewall portions 1 exert separate force or reaction force on the user's feet in order to induce the still point state and interrupt the flexion phase of the sacrum which normalizes a flow of the cerebrospinal fluid.

The sidewall portions 1 interrupt the movement of the user's feet so as to interrupt the flexion phase of the ankles in the craniosacral rhythm caused by the flow of the cerebrospinal fluid. The sidewall portions 1 exert separate force and reaction force on the user's feet so as to induce the still point state and interrupt the flexion phase of the sacrum which normalizes a flow of the cerebrospinal fluid.

Since the extension phase and the flexion phase are caused by the flow of the cerebrospinal fluid, the flow of the craniosacral system may be temporarily stopped by interrupting the flexion phase. The sidewall portions 1 exert elastic force on the user's feet. Therefore, the sidewall portions 1 interrupt the flexion phase by preventing the user's feet from performing the external rotation. Thus, the user is induced to the still point.

The plurality of fixing grooves 10 is formed, and the sidewall portions 1 include an inner sidewall portion 3 formed between the plurality of fixing grooves 10. The plurality of fixing grooves 10 is formed, and the sidewall portions 1 include: the inner sidewall portion 3 which is formed between the plurality of fixing grooves 10; and the outer sidewall portions 5 which are disposed in a direction facing the inner sidewall portion 3 and define outer boundaries of the fixing grooves 10. Two fixing grooves 10 may be formed so the all of the user's feet may be inserted into the fixing grooves 10.

The sidewall portions 1 include the inner sidewall portion 3 and the outer sidewall portions 5, and the inner sidewall portion 3 is formed between the fixing grooves 10. The plurality of outer sidewall portions 5 may be formed, and the inner sidewall portion 3 may be integrally formed to have a symmetrical structure. The outer sidewall portions 5 are formed in the left and right directions, respectively. The outer sidewall portions 5 interrupt the external rotation of the user's feet. The inner sidewall portion 3 interrupts the rotation of the user's heel bone 49.

FIG. 3 is a front view of the leg pillow for physiotherapy according to one exemplary embodiment of the present invention.

Referring to FIG. 3, the inner sidewall portion 3 and the outer sidewall portions 5 define accommodating grooves 20 that extend in a longitudinal direction of the user's thigh 42 and accommodate the user's calves 41 and thighs 42. The accommodating grooves 20 accommodate the user's thighs 42 and calves 41. As described above, the craniosacral therapy needs to correspond to the minute movement of the craniosacral rhythm CSR of the body, and as a result, the user's body may be maintained in as comfortable a posture as possible. Therefore, the thighs 42 and the calves 41 may also be supported.

FIG. 4 is a rear view of the leg pillow for physiotherapy according to one exemplary embodiment of the present invention.

Referring to FIG. 4, the leg pillow for physiotherapy according to one exemplary embodiment of the present invention includes accommodating bottom portions 21 which define bottom surfaces of the accommodating grooves 20, and a connecting point between the fixing bottom portion 11 and the accommodating bottom portion 21 may be formed to be stepped. The leg pillow for physiotherapy may include connecting projections 30 which connect the fixing bottom portions 11 and the accommodating bottom portions 21, respectively, in a stepped manner. The connecting projection 30 is formed between the accommodating bottom portion 21 and the fixing bottom portion 11. The connecting projection 30 is formed at the connecting point between the accommodating bottom portion 21 and the fixing bottom portion 11.

The accommodating bottom portion 21 defines the bottom surface of the accommodating groove 20, and the accommodating bottom portion 21 supports loads of the thigh 42 and the calf 41. The connecting projection 30 is a portion that connects the accommodating bottom portion 21 and the fixing bottom portion 11. The connecting projection 30 is formed in a stepped manner, and divides the accommodating bottom portion 21 and the fixing bottom portion 11.

As another example, the connecting point may be formed horizontally, but the accommodating bottom portion 21 and the fixing bottom portion 11 may be different from each other in respect to density or hardness so that the user's heel is moved downward, and the user's Achilles tendon is curved.

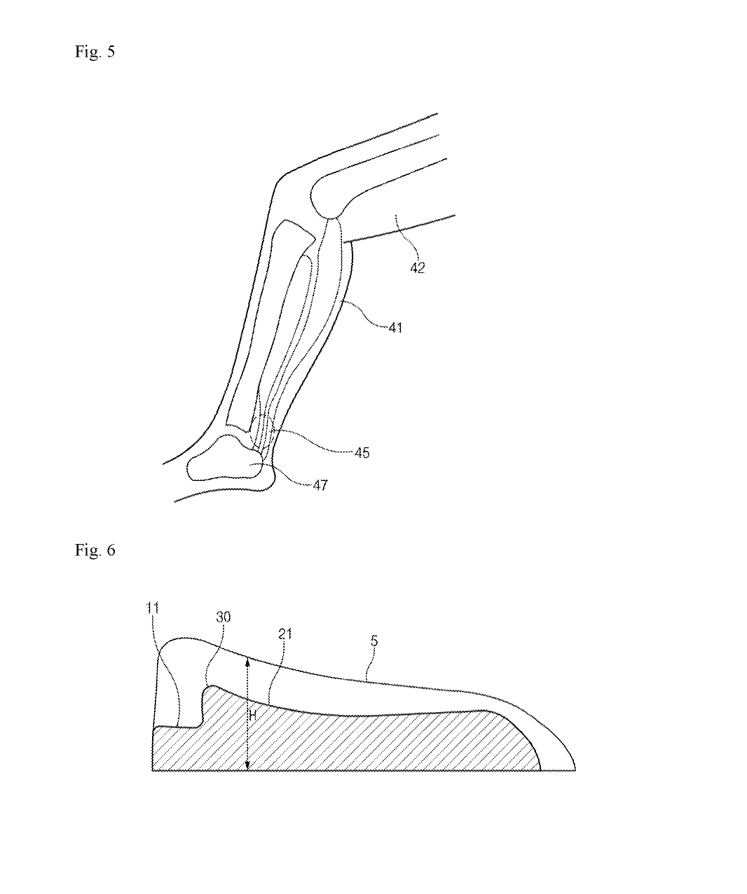

FIG. 5 is a view briefly illustrating a leg part of a human body.

Referring to FIG. 5, at the connecting projection 30, the accommodating bottom portion 21 may be higher than the fixing bottom portion 11. The leg pillow for physiotherapy according to one exemplary embodiment of the present invention includes the accommodating bottom portions 21 which define the bottom surfaces of the accommodating grooves 20 that accommodate the user's calves 41 and thighs 42, and the user's Achilles tendons 45 are placed on the connecting projections 30 between the accommodating bottom portions 21 and the fixing bottom portions 11. The accommodating bottom portion 21 may be formed to be higher than the fixing bottom portion 11. Therefore, the top of the foot accommodated in the fixing bottom portion 11 is flattened. In addition, since the user's Achilles tendon 45 is placed on the connecting projection 30, the Achilles tendon 45 is also relaxed when the foot is curved in the fixing groove 10 by a weight of the foot. Therefore, muscles at the top of the foot, muscles that connect the top of the foot and the leg, and the Achilles tendon 45 are relaxed, and as a result, the user may maintain a more comfortable posture.

FIG. 6 is a cross-sectional view taken along line A-A of FIG. 3.

Referring to FIG. 6, the accommodating groove 20 may have a shape that is gradually lowered, raised, and then lowered again in a direction away from the connecting projection 30. The inner sidewall portion 3 and the outer sidewall portions 5 may have heights H that are gradually decreased in the longitudinal direction of the user's thigh 42.

A height of the accommodating groove 20 is gradually decreased as the accommodating groove 20 extends forward, that is, in a direction away from the connecting projection 30. Because the user's calf 41 is raised convexly, the portion whether the height of the accommodating groove 20 is decreased may correspond to the shape of the user's calf 41. In addition, the accommodating groove 20 may be raised again at a predetermined point, such that a height thereof may be increased. The portion where the accommodating groove is raised again such that a height thereof is increased may be a point that corresponds to the user's knee joint. Since the user's knee joint has fewer muscles than the thigh 42 or the calf 41, a diameter of the accommodating groove 20 at the portion corresponding to the user's knee joint may be reduced. Therefore, the portion corresponding to the user's knee joint may be formed to be higher than the portion for supporting the calf 41.

The accommodating groove 20 may have a shape which is lowered again past the portion for supporting the user's calf 41. This portion supports the user's thigh 42. The thigh 42 has many muscles, and thus a height of the accommodating groove 20 may be smaller than that of the portion for supporting the calf 41. In addition, because the thighs 42 are connected with the gluteus maximus that constitute buttocks, the accommodating bottom portions 21, which constitute the end portions of the accommodating grooves 20, extend in a direction toward the gluteus maximus. However, because the accommodating bottom portion 21 need not support the gluteus maximus, it is acceptable if the accommodating bottom portion 21 has a height of zero at the front of the gluteus maximus.

The inner sidewall portion 3 and the outer sidewall portions 5 may be formed regardless of the heights of the accommodating grooves 20 and support grooves, but the portion, which needs to be fixed to interrupt the flexion phase, is the user's feet. Therefore, in an aspect to induce the user's comfort, it is preferred to maximally inhibit the interference regarding the calves 41 and the thighs 42 which are gradually away from the user's feet.

The leg pillow for physiotherapy according to one exemplary embodiment of the present invention includes: the fixing bottom portions 11 which define the bottom surfaces of the fixing grooves 10 on which the user's feet are seated; the accommodating bottom portions 21 which define the bottom surfaces of the accommodating grooves 20 which are connected with the fixing bottom portions 11 in a stepped manner and accommodate the user's calves 41 and thighs 42; and the sidewall portions 1 which define the lateral surfaces of the fixing grooves 10 and the accommodating grooves 20, and the height H of the sidewall portion 1 may be gradually decreased in a direction from the fixing groove 10 to the user's thigh 42. The height of the sidewall portion 1 may be gradually decreased in a direction from the rear side to the front side. The fixing groove 10 may have a U or V shape.

The leg pillow for physiotherapy according to one exemplary embodiment of the present invention includes: the fixing bottom portions 11 which define the bottom surfaces of the fixing grooves 10 on which the user's feet are seated; the accommodating bottom portions 21 which define the bottom surfaces of the accommodating grooves 20 which are connected with the fixing bottom portions 11 in a stepped manner and accommodate the user's calves 41 and thighs 42; and the sidewall portions 1 which define the lateral surfaces of the fixing grooves 10 and the accommodating grooves 20, and the height of the sidewall portion 1 may be gradually decreased in a direction from the fixing groove 10 to the user's thigh 42. The fixing grooves 10 accommodates the user's feet, and the accommodating grooves 20 accommodate the user's thighs 42 and calves 41.

Since the portion, which minutely moves periodically during the extension phase and the flexion phase, is the foot, the sidewall portion 1 inhibits the movement of the foot in order to inhibit the flexion phase and induce the still point. Therefore, the sidewall portion 1 is formed to be high so that the foot is deeply inserted and fixed into the sidewall portion 1. Meanwhile, it is necessary to inhibit interference regarding the calves 41 and the thighs 42 so that the user may lie comfortably. However, the amount of muscles in the user's calves 41 and thighs 42 vary depending on the user's eating habits and exercising amount, and as a result, the height H of the sidewall portion 1 may be low so as not to restrict the user's thighs 42 and calves 41.

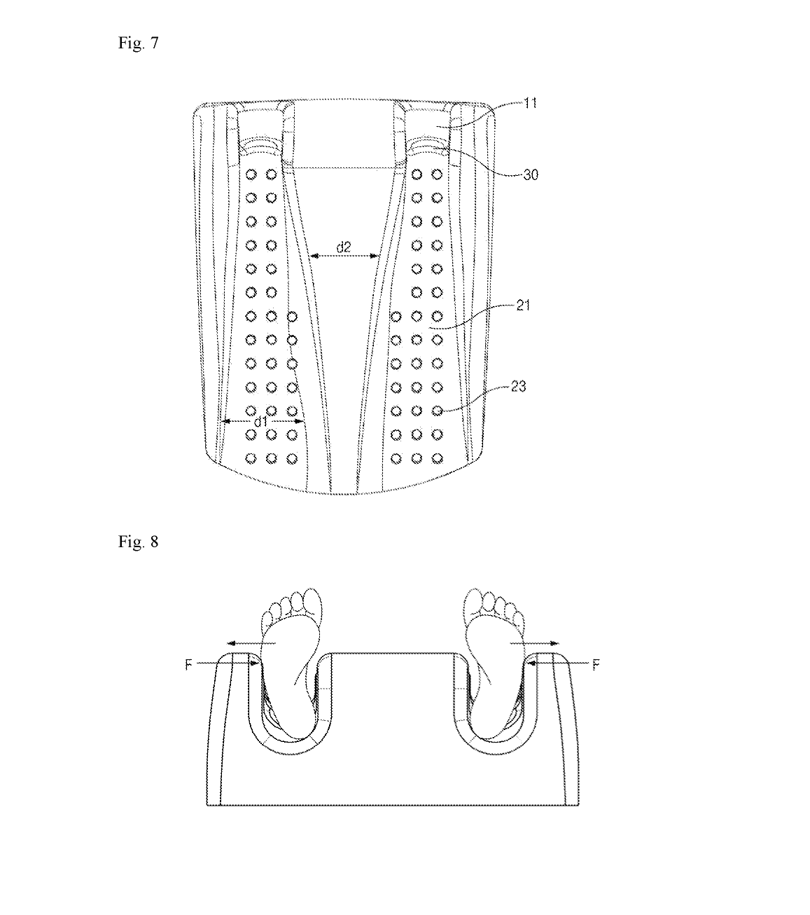

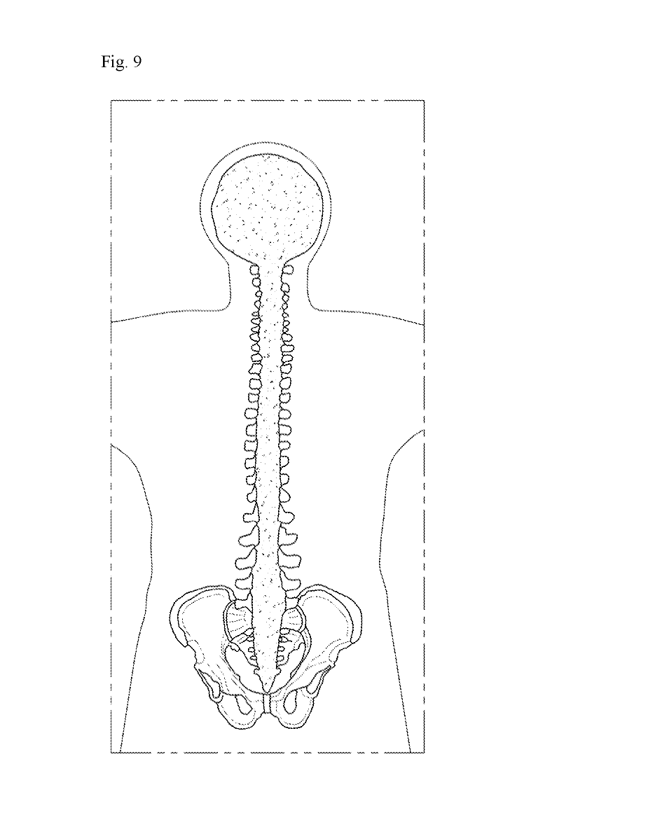

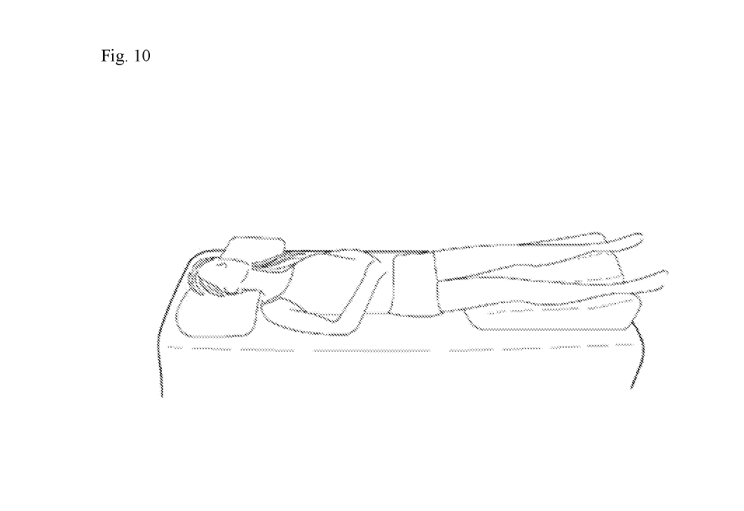

FIG. 7 is a top plan view of the leg pillow for physiotherapy according to one exemplary embodiment of the present invention.

Referring to FIG. 7, a horizontal thickness of the inner sidewall portion 3 may be decreased in a direction toward the user's thigh 42. A horizontal width d1 of the accommodating groove 20 is increased in a direction away from the fixing groove 10. The inner sidewall portion 3 is formed to face inner surfaces of the user's feet. The inner sidewall portion 3 is formed between the fixing grooves 10 and the accommodating grooves 20. Since the thighs 42 have a larger amount of muscles than the calves 41, a horizontal thickness (width) d2 of the inner sidewall portion 3 is decreased in a direction toward the user's thigh 42 (forward). The width d1 of the accommodating groove 20 is gradually increased forward so as to correspond to the thickness d2 of the inner sidewall portion 3.

The leg pillow for physiotherapy according to one exemplary embodiment of the present invention includes the accommodating bottom portions 21 which define the bottom surfaces of the accommodating grooves 20, and have holes 23 recessed vertically. The holes 23 are formed in the accommodating bottom portions 21. The hole 23 is formed vertically to have a predetermined depth. The accommodating bottom portion 21 may be made of an elastic material such as memory foam. The accommodating bottom portion 21 may be deformed when a load is applied due to the user's leg muscles. The accommodating bottom portion 21 has the plurality of holes 23, and may be deformed when a load is applied so that spaces of the holes 23 are decreased. With the plurality of holes 23, the deformation amount of the accommodating bottom portion 21 is increased, and as a result, the accommodating groove 20 may be deformed to surround the user's leg muscles. Therefore, a state in which the user lies in a more comfortable posture may be maintained.

FIG. 8 is a conceptual view illustrating an operation of the leg pillow for physiotherapy according to one exemplary embodiment of the present invention.

Referring to FIG. 8, the sidewall portions 1 inhibit the user's heels from being moved close to each other. Based on the user's toes, the user's toes are moved close to each other during the extension phase. The user's toes are moved away from each other during the flexion phase.

Based on the user's heels, the user's heels are moved away from each other during the extension phase. The user's heels are moved close to each other during the flexion phase. The outer sidewall portions 5 are formed in the left and right directions, respectively. The outer sidewall portions 5 interrupt the external rotation of the user's feet. The inner sidewall portion 3 interrupts the rotation of the user's heel bone 49. The sidewall portions 1 inhibit the flexion phase, thereby preventing the user's heels from being moved close to each other and preventing the user's toes form being moved away from each other. The sidewall portions 1 exert separate force and reaction force F1 and F2 on the user's feet so as to interrupt the flexion phase. The reaction force F1 and F2 may be elastic force.

1. A leg pillow for physiotherapy comprising:
fixing bottom portions which define bottom surfaces of fixing grooves on which a user's feet are seated; and
sidewall portions which extend upward from the fixing bottom portions and define lateral surfaces of the fixing grooves,
wherein the sidewall portions support the user's feet so as to prevent the user's feet from being moved outward away from each other.

2. The leg pillow of claim 1, wherein the sidewall portions include outer sidewall portions which stand up outside the user's feet and interrupt an external rotation of the user's feet.

3. The leg pillow of claim 2, wherein the plurality of fixing grooves is formed, and the sidewall portions include an inner sidewall portion which is formed between the plurality of fixing grooves and interrupts a rotation of the user's heel bones.

4. The leg pillow of claim 3, wherein the inner sidewall portion and the outer sidewall portions define accommodating grooves which extend in a longitudinal direction of the user's thigh and accommodate the user's calves and thighs.

5. The leg pillow of claim 4, further comprising:
accommodating bottom portions which define bottom surfaces of the accommodating grooves; and
connecting projections which connect the fixing bottom portions and the accommodating bottom portions in a stepped manner.

6. The leg pillow of claim 5, wherein the accommodating bottom portion and the fixing bottom portion has a height difference at a portion where the connecting projection is formed, and the fixing bottom portion is lower than the accommodating bottom portion.

7. The leg pillow of claim 5, wherein the accommodating groove has a shape which is gradually lowered, raised, and then lowered again in a direction away from the connecting projection.

8. The leg pillow of claim 4, further comprising:
accommodating bottom portions which define bottom surfaces of the accommodating grooves, and have holes recessed vertically.

9. The leg pillow of claim 3, wherein a horizontal thickness of the inner sidewall portion is decreased in a direction toward the user's thigh.

10. The leg pillow of claim 3, wherein heights of the inner sidewall portion and the outer sidewall portions are gradually decreased in a longitudinal direction of the user's thigh.

11. A leg pillow for physiotherapy comprising:
fixing bottom portions which define bottom surfaces of fixing grooves on which a user's feet are seated;
accommodating bottom portions which are connected with the fixing bottom portions in a stepped manner, and define bottom surfaces of accommodating grooves that accommodate a user's calves and thighs; and
sidewall portions which define lateral surfaces of the fixing grooves and the accommodating grooves,
wherein heights of the sidewall portions are gradually decreased in a direction from the user's end to the user's calf so that the fixing groove is deeper than the accommodating groove.

12. The leg pillow of claim 11, wherein the sidewall portion is formed as an elastic member which is deformed by a weight of the user's foot, and provides elastic force to the user's foot.

13. The leg pillow of claim 11, wherein the plurality of fixing grooves is formed, and the sidewall portions include: an inner sidewall portion which is formed between the plurality of fixing grooves; and outer sidewall portions which are disposed in a direction facing the inner sidewall portion and define outer boundaries of the fixing grooves.

14. The leg pillow of claim 13, wherein a horizontal width of the accommodating groove is increased in a direction away from the fixing groove.

15. A leg pillow for physiotherapy comprising:
fixing bottom portions which define lower surfaces of fixing grooves on which a user's feet are seated; and
sidewall portions which extend upward from the fixing bottom portions and define lateral surfaces of the fixing grooves,
wherein the sidewall portions interrupt the movement of the user's feet so as to interrupt the flexion phase of ankles in craniosacral rhythm caused by a flow of a cerebrospinal fluid.

16. The leg pillow of claim 15, wherein the sidewall portions prevent the user's feet from rotating outward and being spread, and prevent the user's heels from being moved close to each other.

17. The leg pillow of claim 15, further comprising:
accommodating bottom portions which define bottoms of accommodating grooves that accommodate the user's calves and thighs,
wherein the user's Achilles tendon is placed on a connecting projection between the accommodating bottom portion and the fixing bottom portion.
